(19) United States
(12) Patent Application Publication
(10) Pub. No.: US 2010/0099364 A1
(43) Pub. Date: Apr. 22, 2010

(54) System and Method for Transmitting and Error Handling Control Feedback Information

(75) Inventors: Yunsong Yang, San Diego, CA (US); Young Hoon Kwon, San Diego, CA (US); Zhigang Rong, San Diego, CA (US)

Correspondence Address: Slater & Matsil, L.L.P., 17950 Preston Road, Suite 1000, Dallas, TX, 75252, US

(73) Assignee: FutureWei Technologies, Inc., Plano, TX (US)

(21) Appl. No.: 12/604,227

(22) Filed: Oct. 22, 2009

Related U.S. Application Data
(60) Provisional application No. 61/107,629, filed on Oct. 22, 2008.

(51) Int. Cl. H04B 7/00

(52) U.S. Cl. 455/69

(57) ABSTRACT

A system and method for transmitting and error handling control feedback information is provided. A method for error handling in a transmission of control feedback information over a communications link by a first station includes determining a first feedback information at the first station, transmitting the first feedback information at a first instance to a second station, and receiving a scheduling message from the second station. The scheduling message includes a second feedback information, and the second feedback information is based on the first feedback information. The method also includes determining if the first feedback information at the first instance was received correctly by the second station based on the scheduling message, and in response to determining that the first feedback information at the first instance was not received correctly by the second station, transmitting the first feedback information at a second instance to the second station.

This application claims the benefit of U.S. Provisional Application No. 61/107,629, filed on Oct. 22, 2008, entitled “Method for Transmitting Control Feedback Information and for Handling Errors in Such Transmissions,” which application is hereby incorporated herein by reference.

### TECHNICAL FIELD

The present invention relates generally to wireless communications, and more particularly to a system and method for transmitting and error handling control feedback information.

### BACKGROUND

Generally, a communications system's capacity may be significantly improved when a transmitter, e.g., a base station, has knowledge (either full or partial) of information pertaining to a communications channel between itself and a receiver, e.g., a mobile station. The information regarding the communications channel may be obtained by the transmitter via a feedback channel between the transmitter and the receiver.

FIG. 1 illustrates a wireless communication system 100. Wireless communications system 100 includes a base station (BS) 101 and a mobile station (MS) 105, which may be mobile or fixed. BS 101 and MS 105 communicate using wireless communications. BS 101 has a plurality of transmit antennas 115 while MS 105 may have one or more receive antennas 110. BS 101 sends control information and data to MS 105 through a downlink (DL) channel 120 while MS 105 sends control information and data to BS 101 through uplink (UL) channel 125.

In general, a BS, such as BS 101, may also be referred to as a base transceiver station, a NodeB, an enhanced NodeB, and so forth. Similarly, a MS, such as MS 105, may also be referred to as a subscriber unit, a user, a subscriber, a User Equipment, and so on.

MS 105 may send control information on UL channel 125 to improve the quality of the transmission on DL channel 120. BS 101 may send control information on DL channel 120 for the purpose of improving the quality of uplink channel 125. A cell 130 is a conventional term for the coverage area of BS 101. It is generally understood that in wireless communication system 100 there may be multiple cells corresponding to multiple BSs, as well as multiple MSs.

Communications channel information may be in several different forms: preferred band information (PBI) may be an indicator from a mobile station (MS) notifying the base station (BS) serving the MS the bands preferred by the MS; rank indication (RI) may be an indicator from the MS that notifies the BS of the rank of multiple input, multiple output (MIMO) transmissions preferred by the MS; channel quality indicator (CQI) may be an indicator of the quality of the communications channel; and precoding matrix index (PMI) may be an index of a precoding matrix within a precoding codebook to be used to precode transmissions. CQI and PMI may be in the form of full CQI/PMI, which are complete CQI/PMI information, or differential CQI/PMI, which are differences between a current CQI/PMI relative to a full CQI/PMI.

### SUMMARY OF THE INVENTION

These and other problems are generally solved or circumvented, and technical advantages are generally achieved, by embodiments of a system and method for transmitting and error handling control feedback information.

In accordance with an embodiment, a method for error handling in a transmission of control feedback information over a communications link by a first station is provided. The method includes determining a first feedback information at the first station, transmitting the first feedback information at a first instance to a second station, the first feedback information transmitted over a first direction of the communications link, and receiving a scheduling message from the second station, the scheduling message transmitted over a second direction of the communications link. The scheduling message includes a second feedback information, and the second feedback information is based on the first feedback information. The method also includes determining if the first feedback information at the first instance was received correctly by the second station based on the scheduling message, and in response to determining that the first feedback information at the first instance was not received correctly by the second station, transmitting the first feedback information at a second instance to the second station.

In accordance with another embodiment, a method for error handling in a transmission of control feedback information from a station over a communications link is provided. The method includes receiving a first feedback information from the station over a first direction of the communications link on at least one time instance, scheduling a data transmission based on the first feedback information, and transmitting the data transmission and a scheduling message to the station over a second direction of the communications link. The scheduling message includes a second feedback information.

In accordance with another embodiment, a method for transmitting control feedback information is provided. The method includes transmitting a first feedback information over a first feedback channel with a first period, transmitting a second feedback information over the first feedback channel with a second period, and transmitting a third feedback information over a second feedback channel with a third period. The first feedback channel and the second feedback channel are feedback channels on a same direction of a single communications channel.

In accordance with another embodiment, a method for transmitting control feedback information is provided. The method includes transmitting feedback information in a block on an assigned resource over a feedback channel, and repeating transmitting feedback information for other assigned resources. A type of the block is based on a type of the feedback information being transmitted, the type of block determines a number of payload bits in the block, the assigned resource is assigned by a receiver of the feedback information, and an indicator of the type of the block is included with the block.

An advantage of an embodiment is that control feedback information may be tailored to network conditions to help adapt feedback overhead to current network conditions, thereby reducing the cost of feedback when feedback overhead is expensive.

Another advantage of an embodiment is that erroneously received control feedback information may be rapidly detected and retransmitted to help prevent sub-par performance.

A further advantage of an embodiment is that blind detection at both a transmitter and a receiver may be reduced, which may lead to improved transmitter and receiver performance due to reduced processing overhead.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a diagram of a wireless communication system;

FIG. 2 is a diagram of a structure of feedback channels on UL channel between BS and MS;

FIG. 3a is a timing diagram of a first structure of transmissions on a P-FFBCH and a S-FFBCH;

FIG. 3b is a timing diagram of a second structure of transmissions on a P-FFBCH and a S-FFBCH;

FIG. 3c is a timing diagram of a third structure of transmissions on a P-FFBCH and a S-FFBCH;

FIG. 3d is a timing diagram of a fourth structure of transmissions on a P-FFBCH;

FIG. 3e is a timing diagram of a fifth structure of transmissions on a P-FFBCH and a S-FFBCH;

FIG. 3f is a timing diagram of a sixth structure of transmissions on a P-FFBCH;

FIG. 4 is a timing diagram of a structure of transmissions on a S-FFBCH for use in multiple-band feedback;

FIG. 5 is a flow diagram of MS operations in detecting and handling erroneous feedback information;

FIG. 6a is a flow diagram of MS operations in detecting and handling erroneous feedback information; and

FIG. 6b is a flow diagram of BS operations in receiving feedback information from a MS.

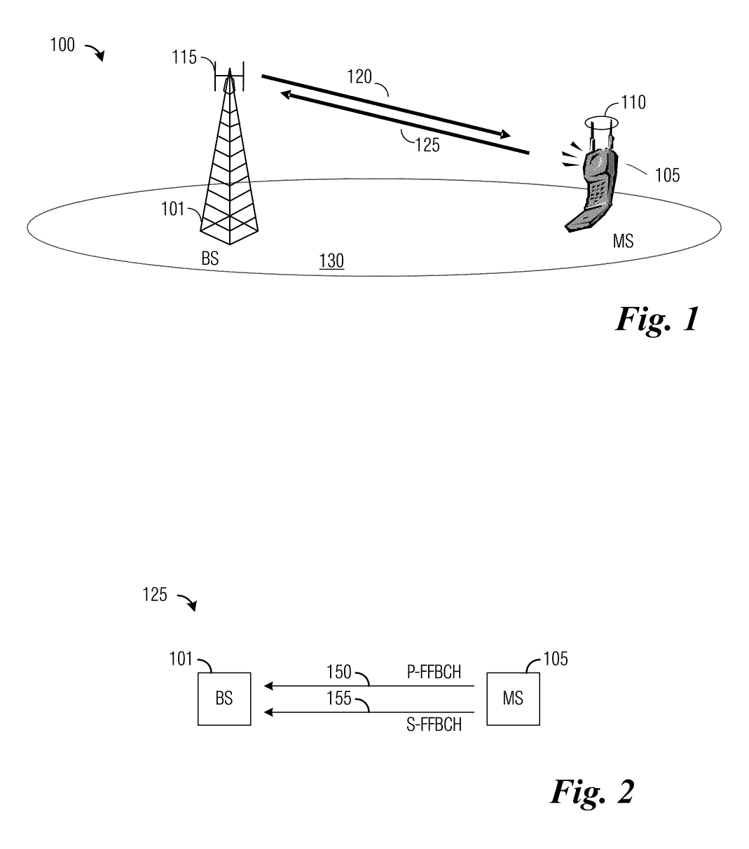

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely an IEEE 802.16m (WiMAX) compliant wireless communications system. The invention may also be applied, however, to other forms of wireless communications systems, wherein there are one or more control information feedback channels that allow for a variety of control information feedback to be feedback to a transmitter.

There may be two general types of feedback mechanisms based on a number of bands being reported. A first being a single-band CQI/PMI feedback mechanism may be provided for cases where a cost associated with feedback is high, such as for a MS operating at a cell-edge and being suitable for closed loop MIMO scheme, such as beamforming, or a MS instructed by its serving BS to report communications channel feedback information in a manner to reduce UL feedback overhead. A second being a multiple-band CQI/PMI feedback mechanism provided for cases where a cost associated with feedback is low (or lower) and a potential gain from advanced MIMO schemes is high, such as for MSs that are suitable for frequency selective closed loop MIMO operation.

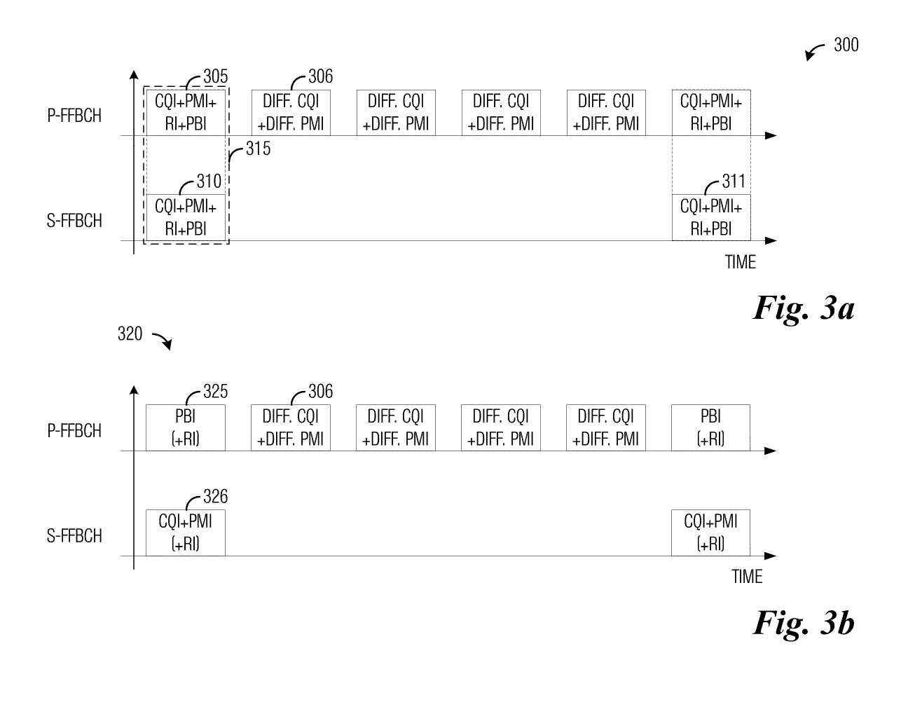

FIG. 2 illustrates a structure of feedback channels on UL channel 125 between BS 101 and MS 105. UL channel 125 includes a primary fast feedback channel (P-FFBCH) 150 and a secondary fast feedback channel (S-FFBCH) 155. Both P-FFBCH 150 and S-FFBCH 155 may be used by MS 105 to provide communications channel information reports to BS 101. Resources for P-FFBCH 150 may be allocated by BS 101 and contents of communications channel information reports may be dictated by BS 101. BS 101 may arrange multiple types of feedback on one P-FFBCH 150 in an interlaced fashion in the time domain. Resources for S-FFBCH 155 may also be allocated by BS 101, but MS 105 may decide on the contents of communications channel feedback information reports carried on the S-FFBCH. MS 105 may either implicitly or explicitly indicate the contents of communications channel information reports carried on the S-FFBCH.

The P-FFBCH and the S-FFBCH may be used separately or in conjunction to allow a MS to provide control feedback information to its serving BS so that the BS may more effectively utilize the available capacity of the communications system. The use of the P-FFBCH and the S-FFBCH may vary and may be based on which (one or both) feedback channels may be allocated to the MS, an amount of network resources available for allocation, and so forth.

In single-band feedback, a BS, such as BS 101, may instruct a cell-edge MS, such as MS 105, which may be suitable for close loop MIMO DL operation to report only one set of PMI and CQI in order to reduce UL feedback overhead. The BS may also instruct any additional MSs operating in close loop MIMO DL operation to report feedback information in a similar manner to reduce UL feedback overhead. The BS may instruct the MS to report wide-band (WB) CQI and PMI. Alternatively, the BS may instruct the MS to report a preferred narrow-band (NB) channel information, as well as CQI and PMI for the preferred narrow band channel.

Communications channel information may also be classified based on their relative rates of change. For example, PBI and RI may likely remain constant (or change very slowly) once they are set or specified, while PMI and CQI may change with greater frequency, especially if the MS is moving around rapidly. Therefore, it may be desirable to update communications channel information based on its expected rate of change. Additionally, if differential communications channel information is used, then the full channel information may need to be updated with less frequency than the differential channel information.

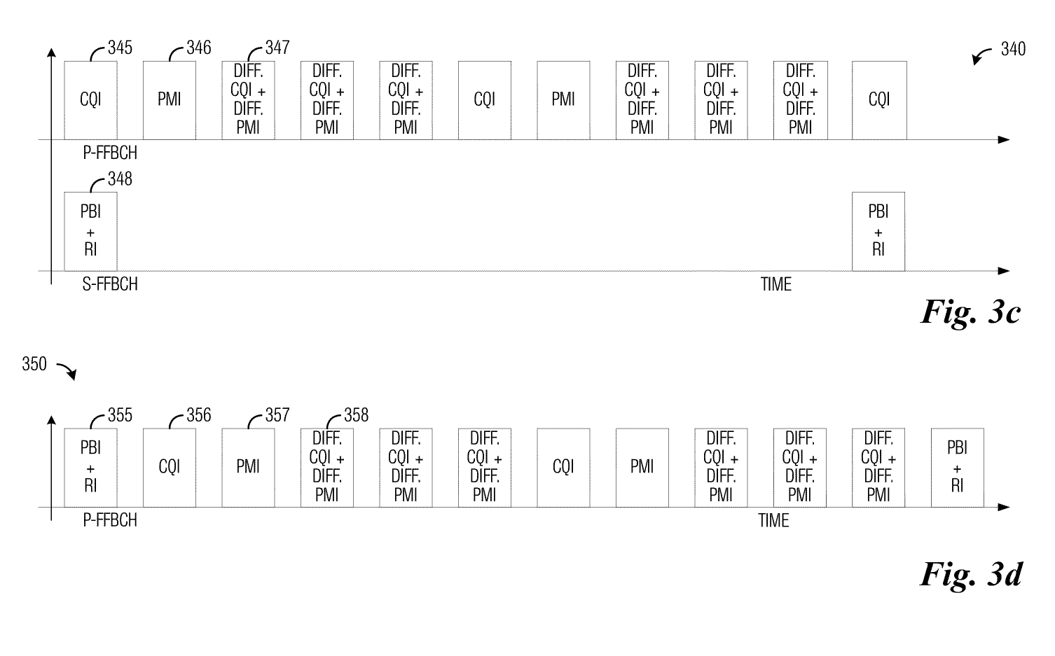

FIG. 3a illustrates a timing diagram of a first structure of transmissions 300 on a P-FFBCH and a S-FFBCH. As shown in FIG. 3a, both P-FFBCH and S-FFBCH are allocated for use by a MS, with the P-FFBCH being allocated more frequently than the S-FFBCH. With more available transmission opportunities on the P-FFBCH than the S-FFBCH, a primary function of the P-FFBCH may be to transmit differential CQI and differential PMI feedback information, such as block 306. With fewer transmission opportunities, the S-FFBCH may be used to transmit full CQI, full PMI, RI, and PBI feedback information together with joint channel coding protection, such as block 310 and block 311.

Although FIG. 3a displays the transmission of differential CQI and differential PMI feedback information, if differential feedback information was not being used, then the blocks used to transmit differential CQI and differential PMI feedback information (e.g., block 306) may be used to transmit full CQI and/or full PMI feedback information.

A network resource allocated for the P-FFBCH and the S-FFBCH may be in a same transmission time interval (TTI) periodically, such as block 305 and block 310 (shown within dashed vertical lines). In this situation, within the same TTI, the network resources allocated to the P-FFBCH (such as block 305) and the S-FFBCH (such as block 310) may be combined into block 315 to carry the full CQI, full PMI, RI, and PBI feedback information.

Alternatively, the P-FFBCH and the S-FFBCH may be a single feedback channel and feedback information transmitted in block 305 and block 310 may be transmitted as a together in a single block (block 315) with a data payload greater than either blocks 305 or 310 separately.

As discussed above, PBI and RI feedback information may change with less frequency than CQI and PMI feedback information (especially, when differential CQI and PMI feedback information is used), therefore the PMI and RI feedback information may be transmitted with less frequency than the transmission of the CQI and PMI feedback information (comparing block 305 versus block 306, for example).

FIG. 3b illustrates a timing diagram of a second structure of transmissions 320 on a P-FFBCH and a S-FFBCH. A difference between first structure of transmissions 300 and second structure of transmissions 320 is evident in the allocation of network resources of TTIs in both the P-FFBCH and the S-FFBCH for the transmission of PBI, CQI, and PMI feedback information, such as block 325 and block 326. The P-FFBCH may be used to carry the PBI feedback information separately in block 325, while the S-FFBCH may be used to carry the full CQI and full PMI feedback information in block 326 so that a modulation and coding scheme used on the P-FFBCH may remain consistent for all TTIs.

The RI feedback information may be carried on either the P-FFBCH or the S-FFBCH depending on whether the number of bits available can allow the inclusion of the RI feedback information without the use of an additional modulation and coding scheme on the P-FFBCH. The restriction of the use of a single modulation and coding scheme only applies on the P-FFBCH. The S-FFBCH may allow the use of multiple modulation and coding schemes. Other TTIs, such as block 306 may be used to carry differential CQI and PMI feedback information as in first structure of transmission 300.

Once again, the rate of change in the communications channel information may have an impact on the frequency of the transmissions of the feedback information. For example, PBI and RI are slowly changing communications channel information, so their transmissions occur with less frequency (blocks 325 and 326) than differential CQI and differential PMI feedback information (block 306).

Although FIG. 3b displays the transmission of differential CQI and differential PMI feedback information, if differential feedback information was not being used, then the blocks used to transmit differential CQI and differential PMI feedback information (e.g., block 306) may be used to transmit full CQI and/or full PMI feedback information.

FIG. 3c illustrates a timing diagram of a third structure of transmissions 340 on a P-FFBCH and a S-FFBCH. As shown in FIG. 3c, the P-FFBCH is allocated more frequently than the S-FFBCH. A primary function of the P-FFBCH is to carry full CQI (e.g., block 345) and full PMI (e.g., block 346) or differential CQI and differential PMI feedback information (e.g., block 347). The full CQI and full PMI or differential CQI and differential PMI feedback information may be arranged in an interlaced fashion. For example, full CQI feedback information may be transmitted in block 345 and full PMI feedback information may be transmitted in block 346. This may be followed by one or more instances of differential CQI and differential PMI feedback information (transmitted in block 347, for example). The S-FFBCH may be used primarily to carry the PBI and RI feedback information, e.g., block 348.

Although third structure of transmissions 340 is shown in FIG. 3c as comprising full CQI feedback information, full PMI feedback information, and three instances of differential CQI and differential PMI feedback information, other particular ordering of feedback information may be possible. Furthermore, the number of instances of differential CQI and differential PMI feedback information may be dependant on factors such as operating environment of MS, MS mobility, channel conditions, desired feedback information resolution and accuracy, and so forth.

Although FIG. 3c displays the transmission of differential CQI and differential PMI feedback information, if differential feedback information was not being used, then the blocks used to transmit differential CQI and differential PMI feedback information (e.g., block 347) may be used to transmit full CQI and/or full PMI feedback information.

FIG. 3d illustrates a timing diagram of a fourth structure of transmissions 350 on a P-FFBCH. As shown in FIG. 3d, only the P-FFBCH is allocated to the MS. The P-FFBCH may be used to carry the PBI and RI feedback information (e.g., block 355), or full CQI feedback information (e.g., block 356), or full PMI feedback information (e.g., block 357), or differential CQI and differential PMI feedback information (e.g., block 358). A frequency in which full CQI or full PMI feedback information is reported may be greater than a frequency in which PBI or RI feedback information is reported, with the relative frequencies being configurable by the BS, or an operator of the communications system.

Although FIG. 3d displays the transmission of differential CQI and differential PMI feedback information, if differential feedback information was not being used, then the blocks used to transmit differential CQI and differential PMI feedback information (e.g., block 358) may be used to transmit full CQI and/or full PMI feedback information.

FIG. 3e illustrates a timing diagram of a fifth structure of transmissions 360 on a P-FFBCH and a S-FFBCH. Fifth structure of transmissions 360 is similar to third structure of transmissions 340 with an exception being that the P-FFBCH may be used to carry full CQI with differential PMI feedback information (e.g., block 365) or full PMI with differential CQI feedback information (e.g., block 366) in an alternating configuration. The alternating of the full CQI with differential PMI feedback information or full PMI with differential CQI feedback information helps to ensure that full control feedback information is available at each TTI and that a wait of at most one additional TTI is required should full feedback information be required. The S-FFBCH may be used to carry PBI and RI feedback information, e.g., block 367.

FIG. 3f illustrates a timing diagram of a sixth structure of transmissions 370 on a P-FFBCH. As shown in FIG. 3f, only the P-FFBCH is allocated to the MS. The P-FFBCH may be used to carry the PBI and RI (e.g., block 375), or full CQI and differential PMI feedback information (e.g., block 376), or full PMI and differential CQI feedback information (e.g., block 377). As with fifth structure of transmissions 360, the alternating of the full CQI with differential PMI feedback information or full PMI with differential CQI feedback information helps to ensure that full control feedback information is available at each TTI and that a wait of at most one additional TTI is required should full feedback information be required.

As discussed above, if differential CQI and differential PMI feedback information are not to be used, then the differential CQI and differential PMI feedback information depicted in FIG. 3a, FIG. 3b, FIG. 3c, or FIG. 3d may be replaced by full CQI or full PMI feedback information in an alternating pattern.

A BS may instruct any MS that is a candidate for frequency selective close loop MIMO DL operation to report multiple NB (and/or WB) CQI and PMI feedback information, as well as preferred band information. If differential CQI or differential PMI feedback information is used, differences in the differential feedback information may be due to time variation, frequency selectivity between sub-bands, spatial layers for multiple stream MIMO scheme, and so forth.

According to an embodiment, all feedback information may be carried on a physical S-FFBCH that includes grouping the feedback information into three types of logical feedback blocks: longer block, long block, and short block. The classification of the feedback information is related to a length of the feedback information cycles.

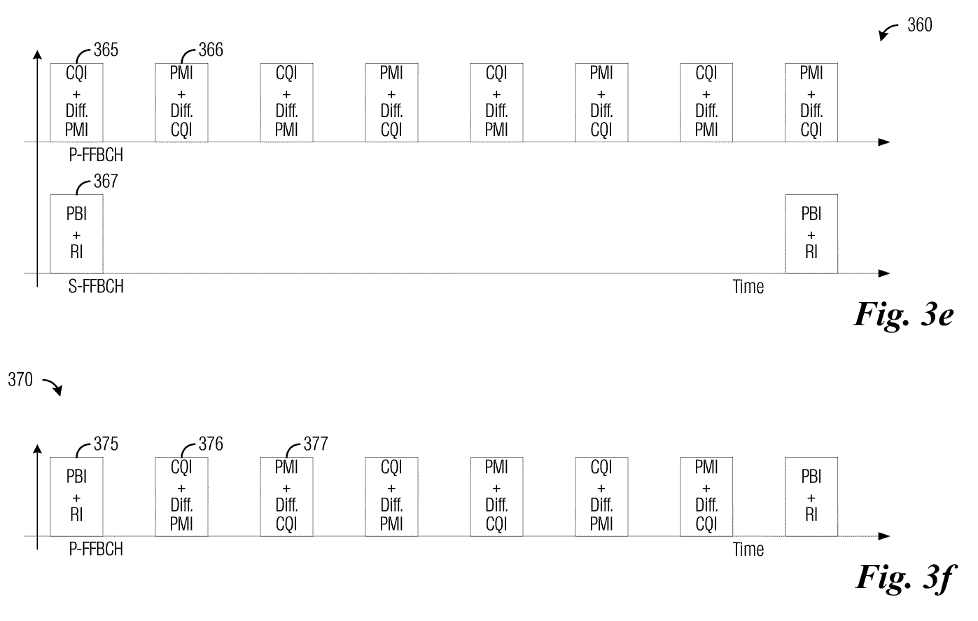

FIG. 4 illustrates a timing diagram of a structure of transmissions 400 on a S-FFBCH for use in multiple-band feedback. Structure of transmissions 400 for use in multiple-band feedback may include longer blocks (such as, block 405) for use in carrying PBI and RI feedback information. The PBI feedback information may be in the form of multiple sub-band indices or a bitmap that indicates the preferred sub-bands, for example. Also included in structure of transmissions 400 are long blocks (such as, block 406) for use in carrying the full CQI and full PMI feedback information for each of the preferred sub-bands or an average CQI for the preferred sub-bands, and short blocks (such as, block 407) for use in carrying differential CQI and differential PMI feedback information for each of the preferred sub-bands. In addition to the feedback information, a cyclic redundancy code (CRC) may be included in a CRC field that may be attached to each of the blocks.

The classification of the block types (i.e., longer, long, and short) may be based on a nature of the communications channel information being feedback, such as, the rate of change of the communications channel information. As an example, the longer block type may be used to transmit slow changing communications channel information, such as PBI and/or RI feedback information, while the long block type may be used to transmit more moderately changing communications channel information, such as CQI and/or PMI feedback information. The short block type may be used to transmit the rapidly changing communications channel information, such as differential CQI and/or differential PMI feedback information.

The network resource for the S-FFBCH may be allocated periodically by the BS. However, the MS may decide autonomously which one of the three block types to report back to the BS at any particular feedback reporting instance. For example, as shown in FIG. 4, when a preferred band information or rank information changes, the MS may provide a longer block to provide feedback information. Furthermore, when differential CQI or PMI feedback information may no longer capture changes in CQI or PMI, the MS may provide a long block to provide full CQI or PMI feedback information.

Since the MS may arbitrarily select to use any one of the three block types, the BS must be able to determine the block type in order to determine the nature of the feedback information. If a single block size (in terms of payload bits) is chosen for all three types of blocks, then there may be a type field (TF) in a block header to indicate feedback block type. If block sizes for the different types of blocks are different (such as shown in Table 1 below, for example), then the BS may blindly detect the S-FFBCH with the three possible block sizes and determine block type according to block size successfully received. Block type may also be indicated as a combination of block size and block header if some block types have the same size and some block types do not. For example, long and short block types may have the same size, while longer block type may have a block size that is different from the long and short block types. Table 1 illustrates exemplary data payloads and feedback information for different block types.

TABLE 1
Payload and Feedback Information for Different Block Types.

| Block Type | Feedback Information Content | Number of bits |
|---|---|---|
| Longer | PBI and RI (slow) | 12 + 2 = 14 |
| Long | CQI + PMI per sub-band (moderate) | (4 + 4) × 3 = 24 |
| Short | Diff. CQI + Diff. PMI per sub-band | (2 + 2) × 3 = 12 |
| | (rapid) | |

If a CRC field is attached to each block, a criterion that may be used to determine a successful reception of the feedback information may be whether or not a CRC check on the data payload of the received block checks with the CRC contained in the CRC field.

Although the discussion above lists three different block types, since the MS may be allowed to utilize different block types in a given network resource depending on the feedback information type, not all three block types may be utilized. For example, depending on the feedback information type, only one, two, or all three block types may be used to transmit the feedback information.

Wireless transmissions are subject to interference and errors. Unforeseen interference and noise from other communication cells, other electronic and electrical devices, and so forth may cause errors in transmissions. Errors in the feedback information may lead to the feedback information being incorrectly interpreted, which may lead to sub-optimal scheduling decisions until correct feedback information is received, replacing the erroneous feedback information.

Error handling may be used at a MS to determine if the BS has received erroneous feedback information and potentially re-transmit the feedback information to the BS to replace the erroneous feedback information. The error handling may depend on the feedback information type. Assistance provided by the BS may help the MS determine if the BS has received erroneous feedback information.

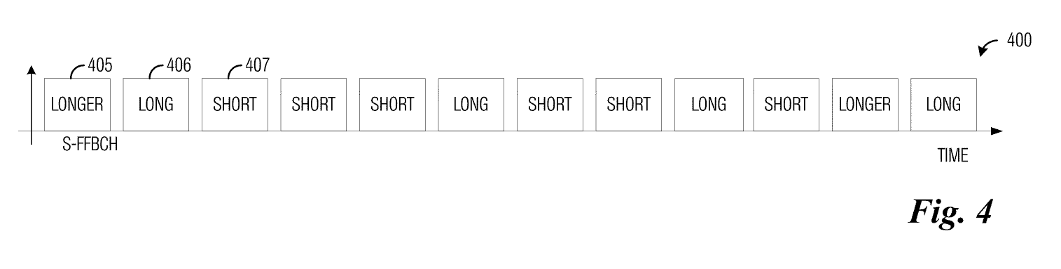

FIG. 5 illustrates a flow diagram of MS operations 500 in detecting and handling erroneous feedback information. MS operations 500 may be indicative of operations taking place in a MS after the MS transmits feedback information (PBI/RI) to its serving BS. MS operations 500 may occur while the MS is in normal operations and may continue until the MS is no longer in normal operations.

Generally, if the PBI/RI feedback information (i.e., longer block type) from a MS is received in error, the BS may persistently make sub-optimal scheduling decisions for the MS until the next PBI/RI feedback information is received correctly. Therefore, it may be desirable to rapidly recover from such an error. Since the PBI/RI feedback information is generally considered to be advisory in nature, the BS may override it by scheduling the MS in a sub-band that is not a subset of the MS's preferred bands (as indicated by the MS).

When the BS overrides the MS, the MS typically cannot tell if the BS received the PBI/RI feedback information correctly or not. In order to overcome this ambiguity, the BS may provide a frequency sub-channel assignment along with an indicator that indicates if the BS has overridden the MS's preferred bands in a DL grant message. For example, the DL grant message may include an override field containing the indicator. The DL grant message may be included as a part of a scheduling transmission from the BS to the MS.

MS operations 500 may begin with the MS receiving a sub-channel assignment in a DL grant message from the BS (block 505). The sub-channel assignment may be in response to PBI and/or RI feedback information provided by the MS. Typically, based on the PBI/RI feedback information and current system conditions, traffic load, and so forth, the BS may assign sub-channels to the MS. The assigned sub-channels may or may not be a subset of the MS's preferred bands. Generally, if the assigned sub-channels are not a subset of the MS's preferred bands, then the BS may indicate that it has overridden the PBI feedback information, e.g., with an indicator in the override field in the DL grant message.

As the MS decodes the DL grant message, the MS may determine if the indicator in the override field is true, i.e., if the BS overrode the MS's preferred bands (block 510). If the BS overrode the MS's preferred bands, then the MS may perform a check to determine if the sub-bands assigned to it is a subset of the MS's preferred bands (block 515).

If the BS overrode the MS's preferred bands and the sub-bands assigned to the MS is a subset of the MS's preferred bands, then the BS may have received the PBI/RI information in error, and the MS may send another PBI/RI feedback information to the BS (block 520). The MS may send the PBI/RI feedback information immediately or at least schedule the transmission of the PBI/RI ahead of its originally scheduled transmission time.

If the BS overrode the MS's preferred bands and the sub-bands assigned to the MS is not a subset of the MS's preferred bands, then the BS may have received the PBI/RI information correctly. The MS may not have to take any action and MS operations 500 may then terminate.

If the BS did not override the MS's preferred bands and the sub-bands assigned to the MS is not a subset of the MS's preferred bands, then the BS may have received the PBI/RI information in error, and the MS may send another PBI/RI feedback information to the BS (block 520). The MS may send the PBI/RI feedback information immediately or at least schedule the transmission of the PBI/RI ahead of its originally scheduled transmission time.

If the BS did not override the MS's preferred bands and the sub-bands assigned to the MS is a subset of the MS's preferred bands, then the BS may have received the PBI/RI information correctly. The MS may not have to take any action and MS operations 500 may then terminate.

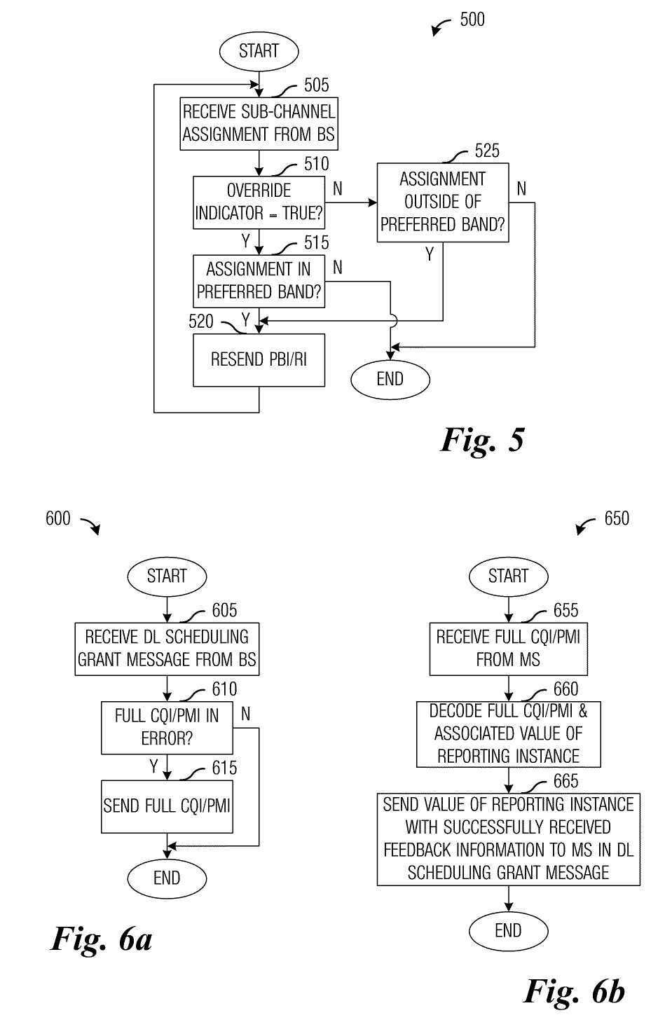

FIG. 6a illustrates a flow diagram of MS operations 600 in detecting and handling erroneous feedback information. MS operations 600 may be indicative of operations taking place in a MS after the MS transmits feedback information (CQI/PMI) to its serving BS. MS operations 600 may occur while the MS is in normal operations and may continue until the MS is no longer in normal operations.

Generally, when differential CQI and/or differential PMI feedback information is used, if the full CQI and/or full PMI feedback information (i.e., long block type) from a MS is not received correctly, the BS may persistently assign transmission opportunities for the MS in a sub-optimal way until another full CQI and/or full PMI feedback information is received correctly. Therefore, it may be desirable to rapidly recover from such an error.

According to an embodiment, the BS may indicate to the MS the latest long block feedback information that it has received in a DL scheduling grant message (sent by the BS to the MS). For example, in the DL scheduling grant message, the BS may indicate a value that is associated with the latest long block feedback information in an explicit field contained in the DL scheduling grant message body.

According to another embodiment, the BS may implicitly indicate the value that is associated with the latest long block feedback information by scrambling, interleaving, or adding a CRC mask on the DL scheduling grant message based on the value. An explicit field may be preferable since it may reduce the number of blind decodes that the MS has to perform when decoding the DL scheduling grant message. For example, the value may be a time index when the latest (i.e., most recent) long block feedback information is received correctly. In a situation where the S-FFBCH resources are assigned by the BS periodically, the time index is known to the BS. Therefore there is no impact on S-FFBCH decoding.

MS operations 600 may begin with the MS receiving a DL scheduling grant message from the BS (block 605). The DL scheduling grant message may explicitly or implicitly contain a value of a reporting instance that is associated with the latest long block feedback information from the MS. For example, the DL scheduling grant message may explicitly contain a field that contains the value of the reporting instance, or the DL scheduling grant message may implicitly contain the value of the reporting instance in its scrambling, interleaving, CRC mask, or so on.

For example, the value of the reporting instance may be a time index of the latest long block feedback information that is successfully decoded by the BS. The MS may have stored a time index of the last time that it sent a long block feedback information to the BS. If the two time indices do not match, then the MS may consider that the full CQI and/or full PMI feedback information was not received correctly by the BS (block 610) and the MS may send another full CQI and/or full PMI feedback information to the BS (block 615). The MS may send the full CQI and/or full PMI feedback information immediately or at least schedule the transmission of the full CQI and/or full PMI ahead of its originally scheduled transmission time. MS operations 600 may then terminate.

The MS may resend the full CQI and/or full PMI that it sent in a latest reporting instance (i.e., the full CQI and/or full PMI that was received in error). Alternatively, the MS may send an updated (i.e., up-to-date) full CQI and/or full PMI, which may or may not be different from the full CQI and/or full PMI that it sent in a latest reporting instance.

If the two time indices match, then the MS may consider that the full CQI and/or full PMI feedback information was received correctly by the BS (block 610). MS operations 600 may then terminate.

In an alternative embodiment, the value of the reporting instance may be a counter value that the MS incrementally changes whenever it sends a long block feedback information. The MS may scramble, interleave, add a mask to a CRC on the S-FFBCH for the long block feedback information based on the value of the reporting instance. The BS may store the value of the reporting instance from the latest correctly received long block feedback information and provides the value of the reporting instance associated with the latest correctly received long block feedback information back to the MS in the DL scheduling grant message. The MS may compare its counter value with the value provided by the BS and decide if the BS correctly received the latest long block feedback information.

FIG. 6b illustrates a flow diagram of BS operations 650 in receiving feedback information from a MS. BS operations 600 may be indicative of operations taking place in a BS that is serving one or more MSs. BS operations 600 may continue while the BS is in normal operations and may continue until the BS is in normal operations.

BS operations 650 may begin with the BS receiving full CQI and/or full PMI feedback information from the MS (block 655). The BS may decode the full CQI and/or full PMI feedback information, and a value of the reporting instance that the MS used to scramble, interleave, add in the form of a mask to the CRC, and so on (block 660). The BS may also determine if the full CQI and/or full PMI was received correctly or in error. Depending on if the full CQI and/or full PMI feedback information was received correctly or in error, the BS may update its value of the reporting instance associated with the latest successfully received long block feedback information. The BS may then use its value of the reporting instance associated with the latest successfully received long block feedback information to scramble, interleave, add in the form of a mask to the CRC, and so on, a DL scheduling grant message transmitted to the MS (block 665). BS operations 650 may then terminate.

According to an embodiment, multiple consecutive differential CQIs and/or differential PMIs are not accumulated before applying them to the full CQI and/or full PMI. Instead, differential CQI and differential PMI is always a difference between a latest reported full CQI and/or full PMI value and a current CQI and/or PMI value. A benefit of not accumulating the differential CQI and/or differential PMI is that error propagation may be avoided. Therefore, there may not be a need to provide feedback of whether a short block type (differential CQI and/or differential PMI) was received correctly or in error.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for error handling in a transmission of control feedback information over a communications link by a first station, the method comprising:
determining a first feedback information at the first station;
transmitting the first feedback information at a first instance to a second station, the first feedback information transmitted over a first direction of the communications link;
receiving a scheduling message from the second station, the scheduling message transmitted over a second direction of the communications link, wherein the scheduling message comprises a second feedback information, wherein the second feedback information is based on the first feedback information;
determining if the first feedback information at the first instance was received correctly by the second station based on the scheduling message; and
in response to determining that the first feedback information at the first instance was not received correctly by the second station, transmitting the first feedback information at a second instance to the second station.

2. The method of claim 1, wherein determining a first feedback information at the first station is based on measurements of the communications link made by the first station at a first measurement instance, and wherein transmitting the first feedback information at a second instance comprises updating the first feedback information based on measurements of the communications link made by the first station at a second measurement instance.

3. The method of claim 1, wherein the first feedback information comprises preferred frequency band information, wherein the second feedback information comprises assigned frequency band information, wherein the scheduling message further comprises an indicator indicating if the first feedback information as received by the second station conflicts with the second feedback information, and wherein determining if the first feedback information was received correctly comprises determining if the first feedback information conflicts with the second feedback information as received by the first station.

4. The method of claim 3, wherein determining if the first feedback information was received correctly comprises:
determining that the first feedback information was received correctly in response to determining that the assigned frequency band information is a subset of the preferred frequency band information and that the indicator indicates that there was no conflict;
determining that the first feedback information was received correctly in response to determining that the assigned frequency band information is not a subset of the preferred frequency band information and that the indicator indicates that there was a conflict;
determining that the first feedback information was received incorrectly in response to determining that the assigned frequency band information is a subset of the preferred frequency band information and that the indicator indicates that there was a conflict; or
determining that the first feedback information was received incorrectly in response to determining that the assigned frequency band information is not a subset of the preferred frequency band information and that the indicator indicates that there was no conflict.

5. The method of claim 1, wherein the first feedback information comprises a full channel quality indicator and/or a full precoding matrix index information, and wherein the method further comprises, storing a first value related to the first feedback information prior to transmitting the first feedback information to the second station.

6. The method of claim 5, wherein the scheduling message further comprises a second value, wherein the second value is related to the first feedback information as received by the second station, and wherein determining if the first feedback information was received correctly comprises:
determining that the first feedback information was received correctly in response to determining that the first value and the second value are equal; or
determining that the first feedback information was received incorrectly in response to determining that the first value and the second value are unequal.

7. The method of claim 6, wherein the first station transmits a plurality of first feedback information at different instances to the second station, wherein the first value comprises a transmission time index of a most recent transmission of the first feedback information, and wherein the second value comprises a transmission time index of a most recent correctly received first feedback information.

8. The method of claim 7, wherein the second value is an explicit field in the scheduling message, or is implicitly indicated in the scheduling message by scrambling, interleaving, or adding a cyclic redundancy code mask to the scheduling message based on the second value, or is a combination thereof.

9. A method for error handling in a transmission of control feedback information from a station over a communications link, the method comprising:
receiving a first feedback information from the station over a first direction of the communications link on at least one time instance;
scheduling a data transmission based on the first feedback information; and
transmitting the data transmission and a scheduling message to the station over a second direction of the communications link, wherein the scheduling message comprises a second feedback information.

10. The method of claim 9, wherein the first feedback information comprises preferred frequency bands, wherein the second feedback information comprises assigned frequency bands, and wherein the scheduling message further comprises a third feedback information, wherein the third feedback information comprises an indicator indicating if the first feedback information received at a most recent time instance conflicts with the second feedback information.

11. The method of claim 9, wherein the first feedback information comprises a full channel quality indicator and/or full pre-coding matrix index information, wherein the scheduling message further comprises a first value related to the first feedback information as received, and wherein the first value is used by the station to determine if the first feedback information was not received correctly at a most recent time instance.

12. The method of claim 11, wherein the first value is a transmission time index of a most recent correctly received first feedback information, and wherein the station determines the first feedback information was received correctly at the most recent time instance if the first value is equal to a second value stored at the station, wherein the second value is a transmission time index of a most recent transmission of the first feedback information.

13. The method of claim 11, wherein the first value is an explicit field in the scheduling message, or is implicitly indicated in the scheduling message by scrambling, interleaving, or adding a cyclic redundancy code mask to the scheduling message based on the first value, or is a combination thereof.

14. A method for transmitting control feedback information, the method comprising:
transmitting a first feedback information over a first feedback channel with a first period;
transmitting a second feedback information over the first feedback channel with a second period; and
transmitting a third feedback information over a second feedback channel with a third period,
wherein the first feedback channel and the second feedback channel are feedback channels on a same direction of a single communications channel.

15. The method of claim 14, wherein the third feedback information comprises slowly changing feedback information.

16. The method of claim 15, wherein the first feedback information comprises slowly changing feedback information and moderately changing feedback information, wherein the third feedback information further comprises moderately changing feedback information, and wherein the second feedback information comprises a differential rapidly changing feedback information of a first type and a differential rapidly changing feedback information of a second type.

17. The method of claim 16, wherein the first feedback channel and the second feedback channel are the same feedback channel, and wherein the first feedback information and the third feedback information are transmitted during a single transmission time interval.

18. The method of claim 15, wherein the first feedback information comprises a full rapidly changing feedback information of a first type, wherein the second feedback information comprises a full rapidly changing feedback information of a second type, and wherein the method further comprises, transmitting a fourth feedback information over the first feedback channel with a fourth period, wherein the fourth feedback information comprises a differential rapidly changing feedback information of the first type and a differential rapidly changing feedback information of the second type.

19. The method of claim 14, wherein the first feedback information comprises a full rapidly changing feedback information of a first type and a differential rapidly changing feedback information of a second type, and wherein the second feedback information comprises a full rapidly changing feedback information of the second type and a differential rapidly changing feedback information of the first type.

20. The method of claim 14, wherein the first feedback channel and the second feedback channel are the same feedback channel, wherein the first feedback information comprises slowly changing feedback information, wherein the second feedback information comprises a full rapidly changing feedback information of a first type, and wherein the third feedback comprises a full rapidly changing feedback information of a second type.

21. The method of claim 20, further comprising, transmitting a fourth feedback information over the first feedback channel with a fourth period, wherein the fourth feedback information comprises a differential rapidly changing feedback information of the first type and a differential rapidly changing feedback information of the second type.

22. The method of claim 14, wherein the first feedback channel and the second feedback channel are the same feedback channel, wherein the first feedback information comprises slowly changing feedback information, wherein the second feedback information comprises a full rapidly changing feedback information of a first type and a differential rapidly changing feedback information of a second type, and wherein the third feedback information comprises a full rapidly changing feedback information of the first type and a differential rapidly changing feedback information of the second type.

23. The method of claim 14, wherein the first feedback information comprises a full slowly changing feedback information of a first type, wherein the second feedback information comprises a differential rapidly changing feedback information of the first type and a differential rapidly changing feedback information of a second type, wherein the third feedback information comprises a full rapidly changing feedback information of the first type and a full rapidly changing feedback information of the second type, and wherein either the first feedback information or the third feedback information further comprises a slowly changing feedback information of a second type.

24. A method for transmitting control feedback information, the method comprising:
transmitting feedback information in a block on an assigned resource over a feedback channel, wherein a type of the block is based on a type of the feedback information being transmitted, wherein the type of block determines a number of payload bits in the block, wherein the assigned resource is assigned by a receiver of the feedback information, and wherein an indicator of the type of the block is included with the block; and
repeating transmitting feedback information for other assigned resources.

25. The method of claim 24, wherein the feedback information comprises slowly changing feedback information, and wherein the type of block is a longer block type.

26. The method of claim 24, wherein the feedback information comprises moderately changing feedback information, and wherein the type of block is a long block type.

27. The method of claim 24, wherein the feedback information comprises rapidly changing feedback information, and wherein the type of block is a short block type.
